(19) United States
(12) Patent Application Publication
(10) Pub. No.: US 2005/0149443 A1
(43) Pub. Date: Jul. 7, 2005

(54) Method and system for conditional acceptance to a group

(76) Inventor: Marko Torvinen, Espoo (FI)

Correspondence Address: CRAWFORD MAUNU PLLC, 1270 NORTHLAND DRIVE, SUITE 390, ST. PAUL, MN, 55120, US

(21) Appl. No.: 10/751,664

(22) Filed: Jan. 5, 2004

(51) Int. Cl. G06F 17/60

(52) U.S. Cl. 705/51

(57) ABSTRACT

In one embodiment, a method and system allows management of restricted group access based upon credentials associated with network terminals. Location information from a location server and capability information from a profile server may provide the credentials that are checked by an application server for compliance with predefined access requirements to the group. Additionally, performance during, for example, a gaming activity may provide performance related credentials that are required for access to performance related groups.

### FIELD OF THE INVENTION

This invention relates in general to group management, and more particularly to management of group memberships using predefined restrictions.

### BACKGROUND OF THE INVENTION

Service enablers are the basic technology building blocks for creating mobile services. The implementation of service enablers can potentially take place in many places along the end-to-end chain, i.e., from the mobile terminal to the fixed network server. Many new service enablers are needed to produce compelling new services and enable the next growth wave for the mobile industry.

The concept of enabling services has largely been perceived between a single service subscriber and a single content server. Often, multiple service subscribers are in need of a single service, where individual sessions between each subscriber and the content server are required. As such, large amounts of resources such as memory and transmission bandwidth are needlessly consumed from the server, since each subscriber requiring service additively drains the server's resources.

Many service enablers in existence today could be more effective and thus provide the subscriber with a richer experience, if -they could be offered and managed in a group fashion based upon common characteristics of the prospective group members. For example, situations where groups of people gathered together within proximity to one another would be able to enhance their experience, if the attendance to the group could be handled adaptively based upon their relative position. In such a group situation, service enablers such as browsing, delivery, messaging, content adaptation, chat, downloading, sharing, presence, etc., could be enhanced by the group structure. Other common characteristics between prospective group members, such as terminal type or terminal capabilities, could also serve as conditions for adaptive group attendance.

In the prior art, however, there exists no mobile or fixed component that adaptively manages user groups by pre-conditioning attendance based upon location, terminal capability, or any other common characteristic. Group management has traditionally been coordinated through the use of group management servers that are fixed within the network, whereby static methods of group management are traditionally implemented through the use of Access Control Lists (ACL). An ACL is a static control list that is an object associated with a file or application containing entries specifying the access that individual users or groups of users have to the file or application.

ACLs provide a straightforward method of granting or denying access for a specified user or groups of users and may be used to a granularity-of a single user, thus they provide an advantage over bitwise permission mechanisms. The ACLs, however, are relatively static and thus are ineffective to manage conditional attendance to groups that are dynamic in nature. Thus, ACLs used within the mobile environment lack the ability to effectively manage group attendance because the ACLs are unable to keep pace with the changing group parameter definitions.

Accordingly, there is a continuing need in the communications industry for a system and method that provides an adaptive mechanism that may be used to condition user acceptance into a group. Such an adaptive mechanism is required due to the volatility of group definitions caused by the dynamic nature of today's mobile environment.

### SUMMARY OF THE INVENTION

To overcome limitations in the prior art, and to overcome other limitations that will become apparent upon reading and understanding the present specification, the present invention discloses a system and method for managing group access criterion in order to regulate group memberships using predefined restrictions.

In accordance with one embodiment of the invention, a method of managing group membership using predefined access restrictions comprises defining access restrictions associated with group membership, comparing credentials received from a prospective group attendee to the predefined access restrictions, and granting group membership to the prospective group attendee when credentials associated with the prospective group attendee meets the predefined access restrictions.

In accordance with another embodiment of the invention, a group management system comprises a plurality of mobile terminals wirelessly coupled to the group management system and adapted to request access to a restricted group. The group management system further comprises an application server adapted to receive group access credentials associated with each of the plurality of mobile terminals and to compare the group access credentials to predefined access restrictions. The group management system further comprises a group management module arranged to update group membership in response to group membership messages received from the application server. A mobile terminal is granted access to the restricted group if the group access credentials associated with the mobile terminal satisfies the predefined access restrictions.

In accordance with another embodiment of the invention, a mobile terminal is wirelessly coupled to a network that includes a restricted access group. The mobile terminal comprises a memory capable of storing a group access module, a processor coupled to the memory and configured by the group access module to submit access requests to the restricted access group, and a transceiver configured to facilitate content exchange with the restricted access group. The credentials associated with the mobile terminal are compared to predefined access restrictions to qualify the mobile terminal for group membership.

In accordance with another embodiment of the invention, a computer-readable medium having instructions stored thereon are executable by a mobile terminal for accessing a restricted group. The instructions perform steps comprising generating an access request to the restricted group located on a network, receiving a challenge in response to the access request, providing a response to the challenge, and receiving access rights to the restricted group when the response is validated by the network. Network access to credentials associated with the mobile terminal is used to determine the access rights of the mobile terminal.

In accordance with another embodiment of the invention, an application server is coupled to a network to facilitate access to a restricted group. The application server comprises a means for receiving requests from network elements to access the restricted group, a means for validating credentials associated with the network elements, and a means for granting access rights to the restricted groups in response to validation of the credentials of the network elements.

In accordance with another embodiment of the invention, a computer-readable medium having instructions stored thereon are executable by an application server. The instructions perform steps comprising receiving requests from network elements to access the restricted groups, validating credentials associated with the network elements, and granting access rights to the restricted groups in response to validation of the credentials of the network elements.

In accordance with another embodiment of the invention, a method of granting access to a restricted group within a network comprises monitoring activity of a terminal within the network, offering restricted group access to the terminal when the activity of the terminal meets a predefined threshold, and updating a group management module with membership changes to the restricted group when the terminal accepts membership to the restricted group.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system and method in accordance with the invention.

### BRIEF DESCRIPTION OF THE DRAWINGS

The invention is described in connection with the embodiments illustrated in the following diagrams.

FIG. 1 illustrates an exemplary block diagram of location definition in accordance with the present invention;

FIG. 2 illustrates an exemplary Session Initiation Protocol (SIP) network in accordance with the present invention;

FIG. 3 illustrates an exemplary game session management diagram in accordance with the present invention;

FIG. 4 illustrates an exemplary message flow diagram in accordance with the present invention;

FIG. 5 illustrates an alternate message flow in accordance with the present invention;

FIG. 6 illustrates an alternate message flow in accordance with the present invention;

FIG. 7 illustrates a representative mobile computing arrangement suitable for defining and accessing group functionality in accordance with the present invention; and

FIG. 8 is a representative computing system capable of carrying out application server functions according to the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system and method that restricts access to potential attendees of a group, based upon various parameters/credentials that are associated with the potential group attendees. Such parameters/credentials may include but are not limited to: location; terminal capability; terminal type; operator subscription; prior group membership; gaming prowess; etc.

Group formation, attendance, and management is conducted through a group management server/component, whereby attendance to the group is conditioned by an application server that is providing access to the restricted group. Location servers, for example, may be used to provide location information associated with mobile terminals, where a mobile terminal's acceptance into a group is based upon the mobile terminal's location relative to a region of interest.

Profile information containing terminal type and terminal capability, for example, may also be used to condition acceptance into a group. A capability of the mobile terminal, e.g., streaming capability, or a particular terminal type, e.g., gaming enabled terminal, may need to meet minimum requirements before a particular mobile terminal is accepted into a group. Parameters such as group subscription or prior group acceptance may also be used to pre-condition acceptance into a particular group activity. Gaming applications, whereby group attendance is conditioned upon a minimum level of performance, may also be implemented in accordance with the present invention.

The present invention thus provides a system and method to manage group memberships using a set of predefined restrictions, which allows dynamic management of group access criteria. The group access may be provided in any of a number of different ways, whereby in a first instance, an end user browses to a Website where he/she may apply for group acceptance. In another instance, an end user may be invited to a group by notification, once group management logic has noticed that the end user has met currently enforced restrictions to group attendance.

In accordance with the present invention, group formation may trigger actions, application downloads, services, etc. (hereinafter generally referred to as “applications”) that are designed to facilitate the group session. For example, multiple chat groups, internal messaging services, application sharing, and demonstration software downloads, to mention only a few, may be utilized during the group session. In addition, other network servers, such as chat servers, Short Messaging Service Centers (SMSC), download servers, etc., may be accessed through standard interfaces to supplement the group session.

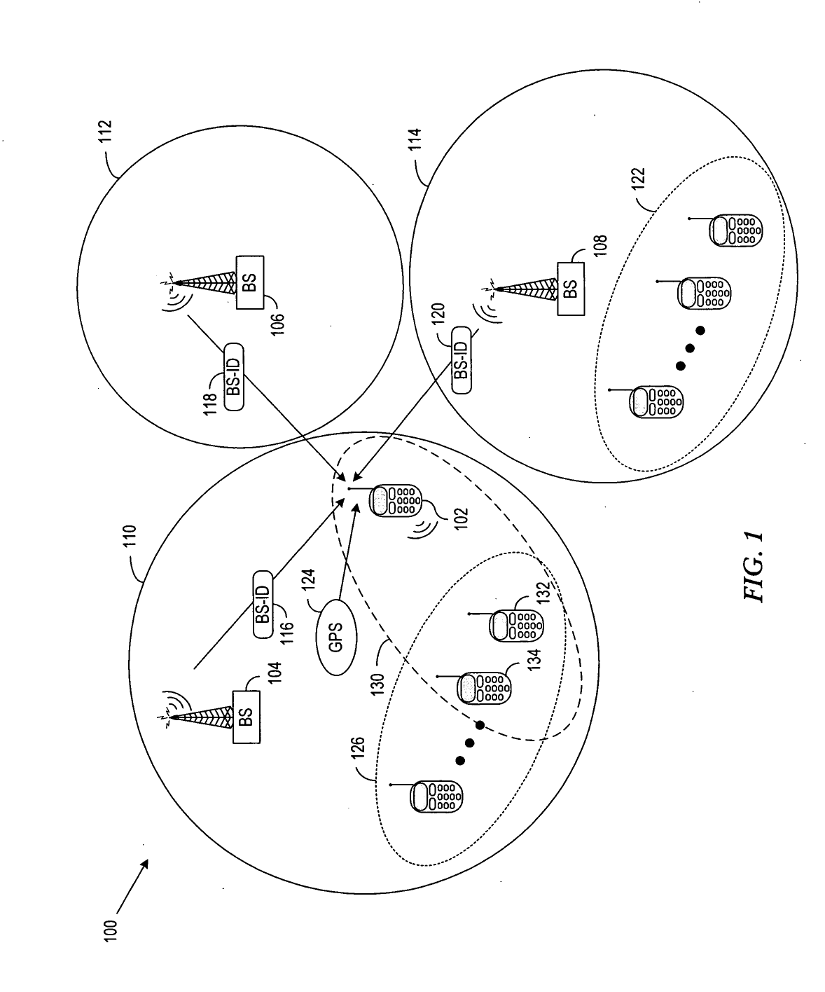

FIG. 1 is a block diagram generally illustrating a number of representative examples in which a mobile terminal can affect group acceptance in accordance with the present invention. The examples set forth in FIG. 1 are provided as representative examples to facilitate an understanding of this aspect of the present invention, however it should be recognized that the present invention is not limited to these representative examples.

FIG. 1 depicts a wireless network environment 100, which may include a cellular network such as the Global System for Mobile Communication (GSM). A portion of the description provided in connection with FIG. 1 is described in terms of a cellular network such as GSM, but the principles described herein are equally applicable to other cellular/wireless networks such as, for example,. Enhanced Data rate for GSM Evolution (EDGE), Personal Communications Service (PCS), and other current or future cellular network technologies. For purposes of discussion and not of limitation, FIG. 1 will be described in terms of a GSM system.

In a mobile radio network such as a GSM network, the area to be covered is divided into multiple areas, generally referred to as “cells.” The mobile radio network is assigned a set of frequencies, and each cell is assigned one (or more) of these frequencies. Neighboring cells will not use the same frequencies, and frequencies are re-used only where the distance is sufficiently large as to avoid interference. When a mobile terminal moves from one cell to another, an automatic channel/frequency change will occur, which is generally referred to as a “handoff” or “handover.” There are different manners in which such a handover may be realized, such as network-based handover, mobile-based handover, and mobile-assisted handover.

In general, a GSM network includes a number of primary subsystems, including a radio subsystem (RSS), a switching subsystem (SS), and an operation subsystem (OSS). The SS connects the wireless network with other networks such as standard public networks, performs handovers between different Base Station Subsystems (BSSs), includes world-wide user location functions, and supports charging, billing, and roaming of users between different service providers. The SS includes elements such as a Mobile Services Switching Center (MSC), a Home Location Register (HLR), Visitor Location Register (VLR), and other elements known in the art. The OSS provides functions for network operation and maintenance, and includes elements such as an Operation and Maintenance Center (OMC), Authentication Center (AuC), Equipment Identity Register (EIR), and other elements known in the art. The SS and OSS, being known in the art and not of particular relevance to the instant discussion, need not be described in further detail.

The RSS includes radio-specific elements, such as the mobile terminals and the Base Station Subsystem (BSS). Referring to FIG. 1, a mobile terminal 102 includes the hardware, software, Subscriber Identity Module (SIM), etc. necessary to communicate with the GSM network. The GSM network includes multiple BSSs, each of which is controlled by a Base Station Controller (BSC). The BSS is responsible for maintaining radio connections to the mobile terminals, coding and decoding, etc. The BSS is a logical entity physically implemented via the BSC and a set of Base Transceiver Stations (BTS), commonly referred to simply as Base Stations (BS), that are controlled by the BSC. In FIG. 1, three of the many available base stations are illustrated, including BS 104, 106, 108. Each BS includes the radio equipment, such as antennas, signal processing, amplifiers, etc. used to facilitate the communication between the BSC and the mobile terminals. The wireless area served by a BS is generally referred to as a cell, such that cell 110 is served by BS 104, cell 112 is served by BS 104, and cell 114 is served by BS 108.

In a cellular network such as the exemplary GSM network portion illustrated in FIG. 1, a number of identifiers are used to identify the various network constituents. For example, the mobile terminals 102 are generally associated with an equipment identifier, and the user of the mobile terminal 102 is generally associated with a subscriber identifier (such as that provided by a SIM) as well as with an identifier such as a telephone number. In addition, several other identifiers are defined for managing subscriber mobility and addressing other network elements.

Among these other identifiers are the cell identifier (cell-ID) and the Base Transceiver Station Identity Code (BSIC). To understand these identifiers, it is noted that a GSM network includes various geographic areas, including cells, Location Areas (LAs), MSCJVLR service areas, and Public Land Mobile Network (PLMN) areas. As previously indicated, a cell is the area generally corresponding to a BS radio coverage area, and is identified via the cell-ID. The LA is a group of cells, and corresponds to the area in which subscribers are paged, where paging refers to the act of broadcasting over the setup channel in order to locate a mobile terminal. Each LA is served by one or more BSCs and by a single MSC. Each LA is assigned a location area identity (LAI) number.

Within a particular LA, the individual cells are uniquely identified with a cell-ID. Together with the LAI, cells can be uniquely defined on an international level. As to the BSIC, a unique BSIC is used in order to distinguish neighboring base stations. For example, the BSIC includes a color code within a PLMN referred to as the Network Color Code (NCC), and a Base station Color Code (BCC). The purpose of the color codes is to provide a manner for the mobile terminal to distinguish between two different cells using the same radio transmission frequency. Within the same network, the identification can be performed using the BCC, where overlapping networks further utilize the NCC. The BSIC is broadcast periodically by the base station on the Synchronization Channel (SCH).

Returning to FIG. 1, one embodiment of the invention involves receiving one or more cell-related identifiers at the mobile terminal 102, which can then be used by the mobile terminal 102 to determine approximately in which cell boundary 110 he is located. This location information can then be used by an application server (not shown) to grant group access rights to each mobile terminal within cell boundary 110. In particular, the mobile terminal performs signal strength measurements and bit error rate measurements on the received signal on the channel it is currently operating on, as well as signal strength measurements on a list of candidate channels supplied to it by the BS. For example, mobile terminal 102 can perform signal strength measurements for the channel associated with BS 104, as well as other base stations such as BS 106, 108. In this manner, the mobile terminal 102 creates and maintains a list of current base stations that are in range. More particularly, mobile terminal 102 will receive a unique base station identifier 116, such as the cell-ID and/or BSIC, from BS 104, as well as such identifiers 118, 120 from other base stations 106, 108 respectively. This information can be used by a mobile terminal-specific implementation to identify the area served by one or more of the list of base stations. In particular, mobile terminal 102 may ascertain which of cells 110-114 is currently servicing mobile terminal 102 and further may ascertain which of mobile terminal groups 126 or 122 share the same cell with mobile terminal 102. Thus, mobile terminal 102 may provide cell based location information through inclusion of each active mobile terminal that is currently sharing the same cell, e.g., mobile terminal group 126. In this way, each mobile terminal sharing the same cell would automatically meet the location criteria for group access by virtue of its location within the cell.

In accordance with another embodiment of the invention, mobile terminal 102 may employ a proximity connection to ascertain which of mobile terminals 126 are within sub-group area 130, e.g., through the use of a Bluetooth connection. Bluetooth is a computing and telecommunications industry specification that describes how mobile phones and other mobile terminals can interconnect with each other and with home and business phones/computers using a short-range wireless connection. A Bluetooth hot spot, e.g., 130, is an area that has a readily accessible wireless network available to multiple terminals within that area, e.g., mobile terminals 132-134 and 102. Thus, each of mobile terminals 132 and 134 having similar Bluetooth capability that fall within sub-group area 130 may be identified by their position as potential participants in a location restricted group activity. Other implementations of proximity connections may be utilized to define sub-group 130, such as Wireless Local Area Network (WLAN) or InfraRed (IR) for example, and are not necessarily limited to a Bluetooth application.

In another embodiment of the present invention, mobile terminal 102 may define a more detailed description of location criteria. For example, mobile terminal 102 may define a particular region of interest so that location based group access is confined to an area that is defined by the user of mobile terminal 102. The region of interest may be defined by the user in any number of different ways. The region of interest may be defined, for example, by giving the name of the city, or one of the streets in the city, with text or voice input. A known landmark may also be entered to define a region of interest, such as for example, the Stockmann in Finland, or the Leaning Tower of Pisa in Italy. A user may also select a region of interest by viewing a map display of a wide area and pointing to an area within the wide area view and then zooming to the area pointed to. The user may also have access to a positioning system, e.g., GPS 124, used to determine his current position, in which case, his current position not only defines the center of the region of interest to be used, but also defines the outer boundaries of the region of interest to be used. Through the use of GPS or landmark aided region of interest definition, for example, the user of mobile terminal 102 may store coordinates of the region of interest and transmit them to an application server for later usage. In this way, each terminal within the region of interest would gain access rights to any location sensitive group by virtue of its position within the region of interest, as may be verified by the application server in combination with a location server.

Still in other embodiments, the user may wish to pinpoint a central datum point on a map that is currently within the viewable display of the mobile terminal. In such an instance, the user simply picks the central datum point by selecting a point on the viewed map using a stylus, mouse, or any other suitable pointing device. Once the central datum point is selected, the region of interest may also be selected by the user so as to control the size of the region of interest which surrounds the central datum point. The region of interest may also be defined by simply taking a circumference around the central datum point according to a selectable circumference radius.

Map data representative of the region of interest and surrounding areas may be stored locally within mobile terminal 102, whereby map data is retrieved from local memory. Alternatively, map data representative of the region of interest may not be located locally to the mobile terminal, in which case map data is retrieved from a download server (not shown). The map data may then be displayed to the user via the display of mobile terminal 102, whereby the user is then able to superimpose a region of interest onto the displayed map to define the boundaries of the location sensitive group.

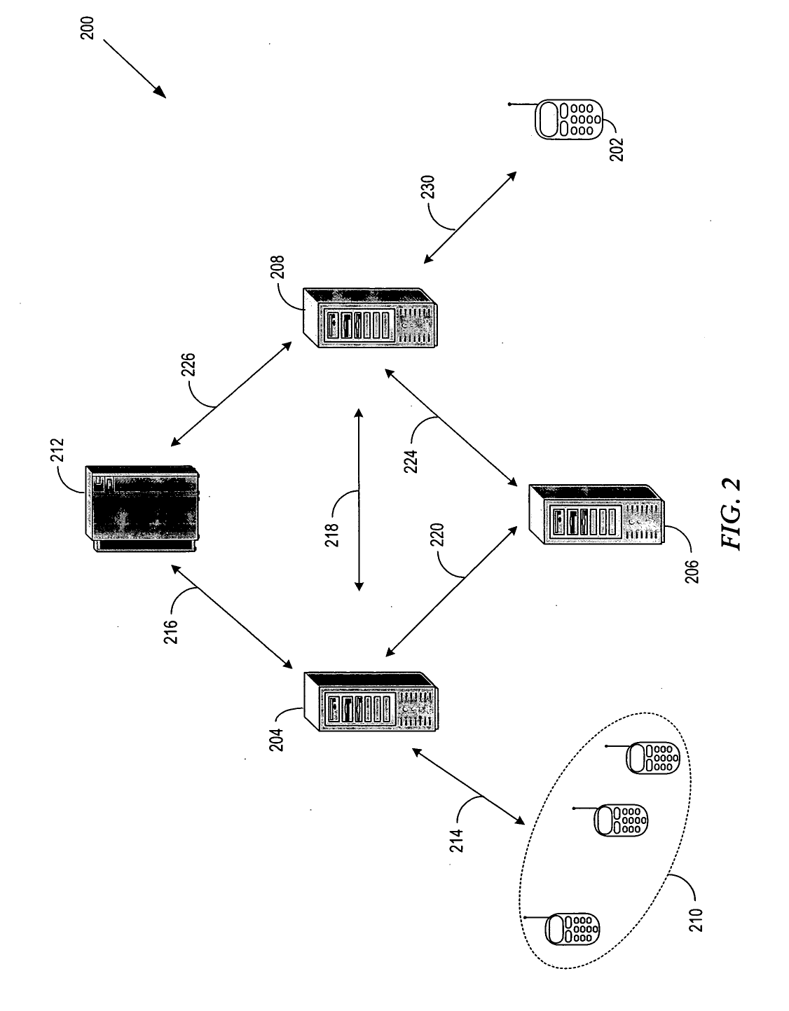

Application/location/group management components may be used in combination with a mobile terminal to manage group memberships using predefined restrictions in accordance with the present invention. In such an instance, certain location, capability, or other predefined conditions are enforced by the various server components, which must be met before a prospective terminal is allowed access into the group. An exemplary network that may be used to manage such information is Session Initiation Protocol (SIP) network 200 of FIG. 2.

FIG. 2 illustrates an exemplary SIP network according to the principles of the present invention, in which credentials associated with, for example, prospective group terminals 210 may be provided to SIP server 208 in order to facilitate group membership. Elements of a SIP enabled network include user agents, e.g. mobile terminals 202 and 210, SIP servers 204 and 208, location server 206, and profile server 212. User agents are the end devices in a SIP network and they originate SIP requests to establish media sessions to send and receive media. Each user agent comprises a user agent client that initiates requests and a user agent server that generates the responses to the requests.

SIP servers 204 and 208 are servers that assist user agents in session establishment and other functions. SIP servers may represent a SIP proxy that receives SIP requests from a user agent, via paths 214 or 230, or another proxy, via path 218, and forwards the request to another location. SIP servers may also represent a redirect server that receives a request from a user agent or proxy and returns a redirection response indicating where the request should be retried. SIP servers may also represent a registrar server that receives SIP registration requests and updates the user agent's information into a location server, e.g., 206, or other database, via paths 220 or 224. SIP servers 204 and 208 may also access capability information from profile server 212 via paths 216 and 226 associated with either of user agents 202 and/or 210 according to their respective access privileges defined by their user agent profiles. Likewise, SIP servers 204 and 208 may also access location information associated with either of user agents 202 and/or 210 from location server 206 via paths 220 and 224.

Servers 204-208 and 212, for example, may be operated as location/capability/management components used to facilitate group formation decisions in accordance with the present invention. Conditional attendance into a group session may be monitored by SIP server 208 through analysis of various features associated with prospective group terminals 210. In particular, SIP server 208 may issue an OPTIONS message to SIP server 204 in order to ascertain any pertinent options or capabilities that are associated with prospective group terminals 210. Once the request is authenticated, SIP server 204 may access profile server 212 to retrieve the requested information. Once received, SIP server 204 then forwards the requested information to SIP server 208, where the capabilities associated with prospective group terminals 210 may be compared to predefined attendance criteria. Location information from location server 206 may be similarly obtained to condition group acceptance of group terminals based on their respective position.

Any number of conditional attendance parameters may be used to ascertain conditional acceptance to a group session. Terminal capabilities, such as streaming capability, may be a pre-requisite to allow a prospective terminal to join a group session so that efficient data communication between group members may be insured. Terminal type, e.g., gaming enabled terminals, may also be a required capability to join, for example, a location based gaming demonstration. Such a prerequisite might be enforced in order to insure that all members of the group are compatible with the gaming demonstration that is offered within a particular group session. Location of each prospective terminal 210 may be another parameter accessed by SIP server 208 from, for example, location server 206 to further condition the acceptance into the group session. Any of prospective group terminals 210 conforming to the conditional criteria may then be used to generate a prospective group member list, from which a group session may be formed.

In accordance with another embodiment of the present invention, game session management 300 may be employed to use gaming performance 318 of user 302 as a precondition to join one of gaming groups 304-308. Gaming server 310, in combination with a group management application executing on application server 312, provides gaming management for gaming groups 304-308 and gaming user 318. Each of the mobile terminals in the respective gaming groups have been organized into their respective proficiency levels, whereby gaming group 304 has the highest proficiency, e.g., expert, gaming group 306 has the next highest proficiency, e.g., intermediate, and gaming group 308 has the lowest proficiency, e.g., novice.

Once mobile terminal 302 has completed the particular gaming session, a new high score 318 is reported to gaming server 310. The new high score is then compared to the proficiency levels of gaming groups 304-308 by gaming server 310. Since, for example, a high score of 1,501,865 qualifies mobile terminal 302 for the expert gaming group 304, gaming server 310 invites gaming terminal 302 into expert gaming group 304 based upon new high score 318. Upon acceptance of the invitation by mobile terminal 302, gaming server 310 provides application server 312 with end user information associated with mobile terminal 302, including new high score 318. Once the end user information has been provided to application server 312, the group management function adds user 302 to expert group 304. It should be noted that although terminals 302-308 are illustrated as being mobile terminals, they may also be land based terminals, such as Personal Computers (PCs), that may network with gaming server 310 and application server 312 via a wired network such as the Internet.

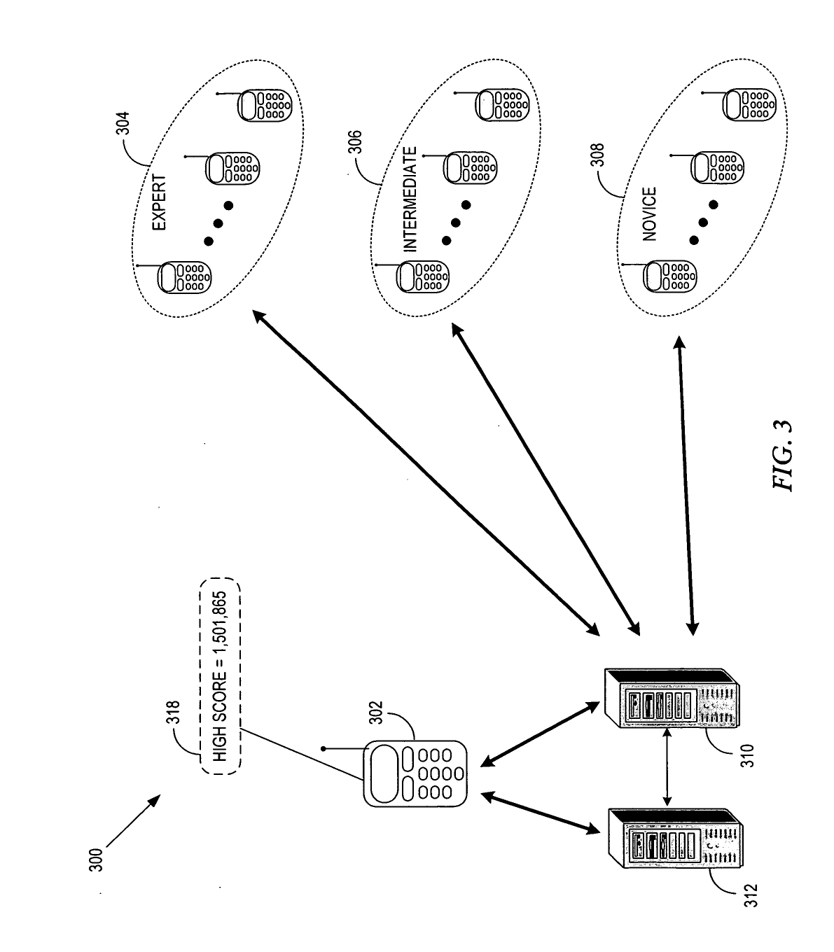

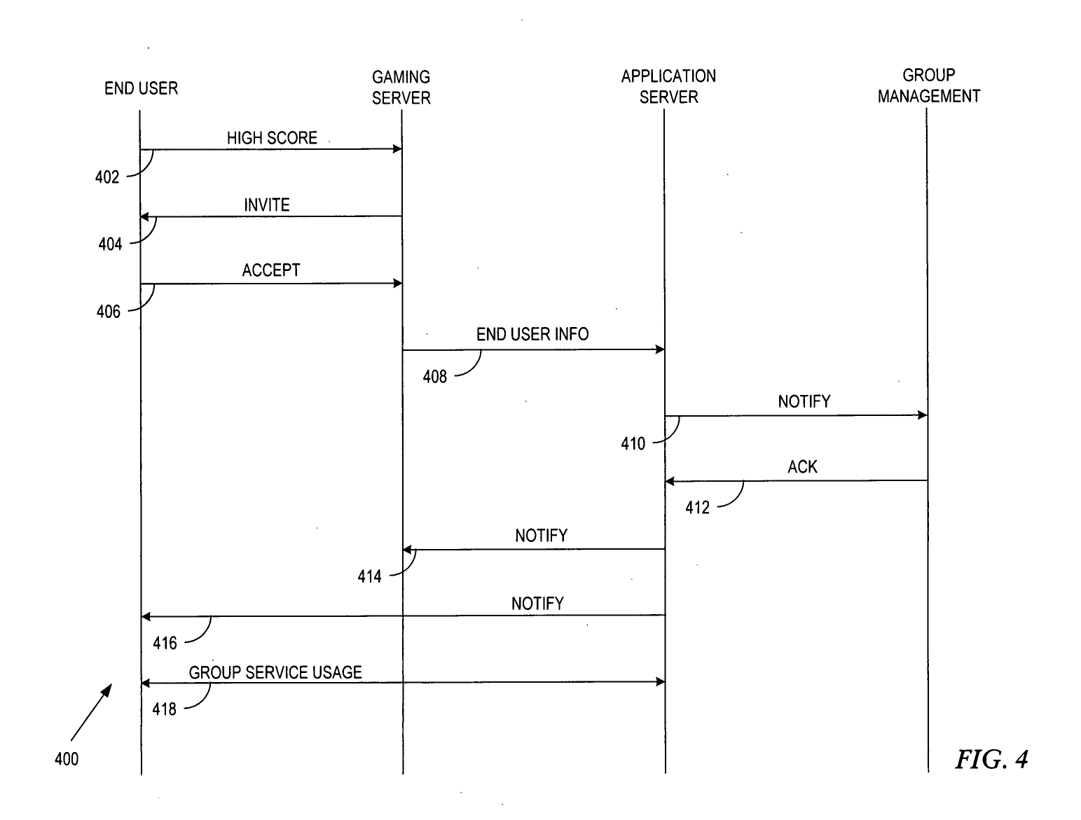

One method according to the present invention of facilitating group access is through the use of invitations. In order to illustrate group membership by invitation, exemplary message flow 400 of FIG. 4 is provided and explained in relation to gaming session management 300 of FIG. 3. End user 302 is participating in a gaming session with gaming server 310 and finally surpasses a predefined limit of 1,000,000 points. Once the game has ended, the ultimate high score of 1,501,865 is reported to gaming server 310 via message 402. After comparison of high score 318 to predefined limits, gaming server 310 ascertains that end user 302 has achieved, for example, expert status and is qualified for membership into expert group 304. Based upon the exemplary performance exhibited by end user 302, gaming server 310 invites end user 302 to expert gaming group 304 via message 404. End user 302 then has the option to join expert group 304 by invitation. End user 302 may, for example, be prompted via visual display that he has attained expert status and may then be provided the option to either accept or deny the invitation to join expert group 304. Message 406 represents the acceptance by end user 302 into expert group 304.

Upon receipt of message 406, information associated with end user 302 is provided to application server 312 via message 408, so that the group management application (not shown) executing on application server 312 may be updated as to the additional membership to expert group 304 via message 410. Acknowledgement of the membership update is then provided by the group management application to the gaming server via messages 412 and 414. Message 416 then provides end user 302 with the Uniform Resource Locator (URL) and access credentials that are needed to access expert group 304. Once provided with the necessary access and credential information, end user 302 may then access expert group 304 on application server 312 to begin group service usage 418.

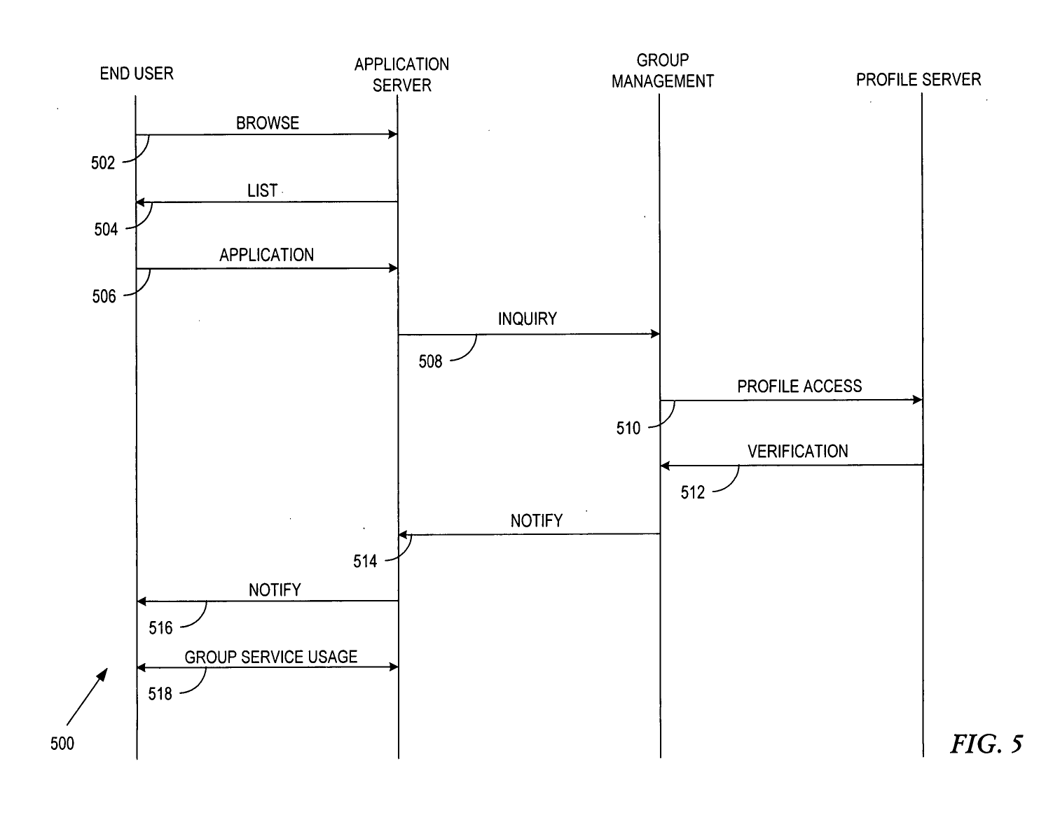

In an alternate embodiment according to the present invention, user groups may be created by network operators to promote customer loyalty to them. For example, user groups may be set up by the network operator, so that the subscribers of the network may gain access to beneficial services offered by the user groups. In order to gain access to the user groups, however, a user must first meet a precondition for group acceptance, i.e., validation of the user's subscription to the operator's network. FIG. 5 illustrates exemplary message flow 500, whereby an end user may browse various group offerings, apply to interesting groups, and subsequently obtain group acceptance by virtue of his prior subscription with the group's sponsor.

In message 502, an end user accesses a Web page containing advertisements for specialized group access and subsequently receives the list of groups in message 504 that pertains to the end user's request. Once the user has located the particular group of interest, he applies for group access via message 506, whereby the user's identification is included within the request to the application server. The user's identification may be, for example, a Mobile Station Integrated Services Digital Network (MSISDN) number or a pseudonym for the end user. In the case of a pseudonym, an interpreter (not shown) would be necessary to convert the pseudonym into a recognizable user identification.

An inquiry is then made to a group management application in message 508 concerning the end user's access to the selected group. The group management application must then access a profile server that is associated with the end user via message 510, so that the profile information may be accessed based upon the user's identification provided in message 506. The information requested by message 510 may include, for example, any capability or configuration information associated with the end user. In addition, the information requested by message 510 may include subscription information that is associated with the end user. Any subscriptions correlating to, for example, the requested group of message 506 results in providing the end user with the necessary precondition to be accepted into the requested group. Upon meeting the necessary precondition, verification message 512 is sent to the group management application and subsequently forwarded onto the application server via message 514. The application server then forwards any necessary information via message 516, such as URL or credential information, that may be required by the end user in order to access the requested group. Upon receipt, the end user is then free to access the group service via message 518 using the URL and credential information received in message 516.

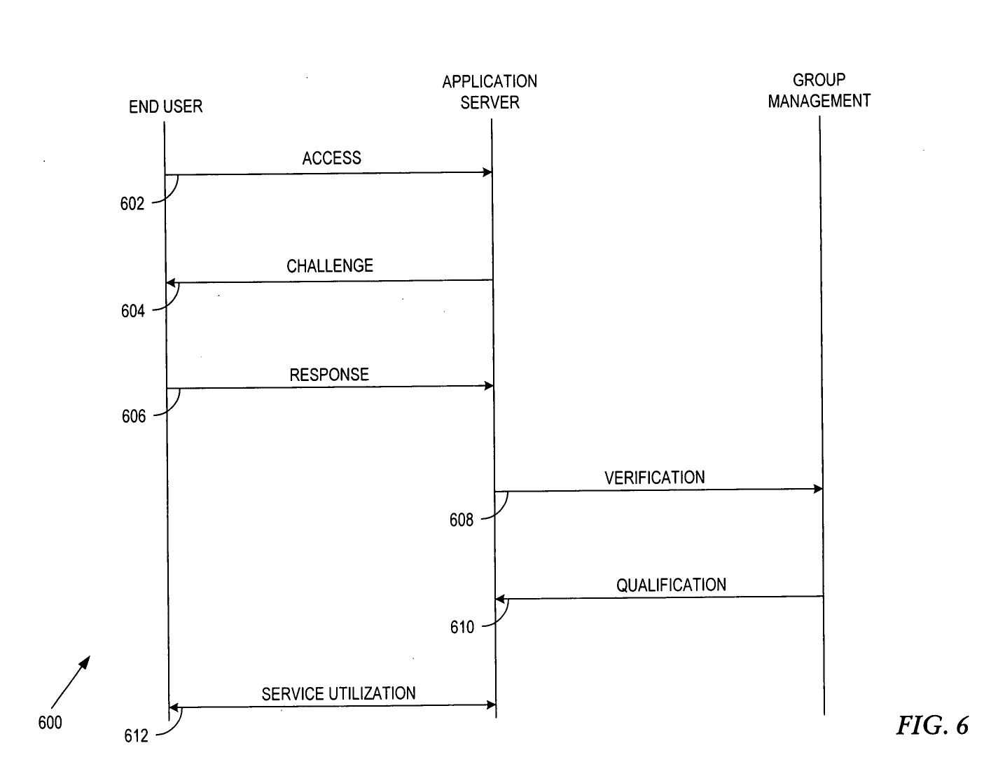

Once the end user has gained prior group membership, access to the group may be performed in abbreviated fashion in accordance with the present invention as illustrated by message flow 600 of FIG. 6. In message 602, the end user accesses the URL associated with the group of which the end user is already a member. The application server receiving the access request of message 602 challenges the end user with the identification request of message 604. In response, the end user may respond with, for example, his MSISDN or pseudonym as in message 606. The identification of the end user is then forwarded to the group management application in message 608 for verification of group membership. Once validated, the group management application returns the end user's qualified status in message 610 as to his conditioned usage of the group. Finally, the end user is granted service utilization within the conditioned group as illustrated by message 612.

The present invention allows the implementation of group membership management through the use of predefined group acceptance restrictions. By allowing group access criteria to be altered dynamically, many use cases may be envisioned, where it is desirable to implement relatively open group access, while also providing some degree of access restriction. These quasi-open groups, for example, allows the creation of user groups that are dependent upon the relative location of the members of the group, e.g., during group events like outdoor concerts or museum tours. The quasi-open groups of the present invention further allows multiple groups to be formed that are related to each other, but that also require segregation, e.g., separation of the various proficiency levels of gamers into expert, intermediate, and novice sub-groups. Still further, the present invention allows automation of dynamic group management, whereby operators can create a group with predefined access restrictions that may then be allowed to develop freely with little supervision. Still further, individualized services may be offered to specific user groups through the use of the present invention. For example, users taking part in a museum tour may gain restricted access to interesting, Web based content simply by virtue of their relative position to one another. In general, therefore, greater personalization of group services may be offered through the use of the present invention.

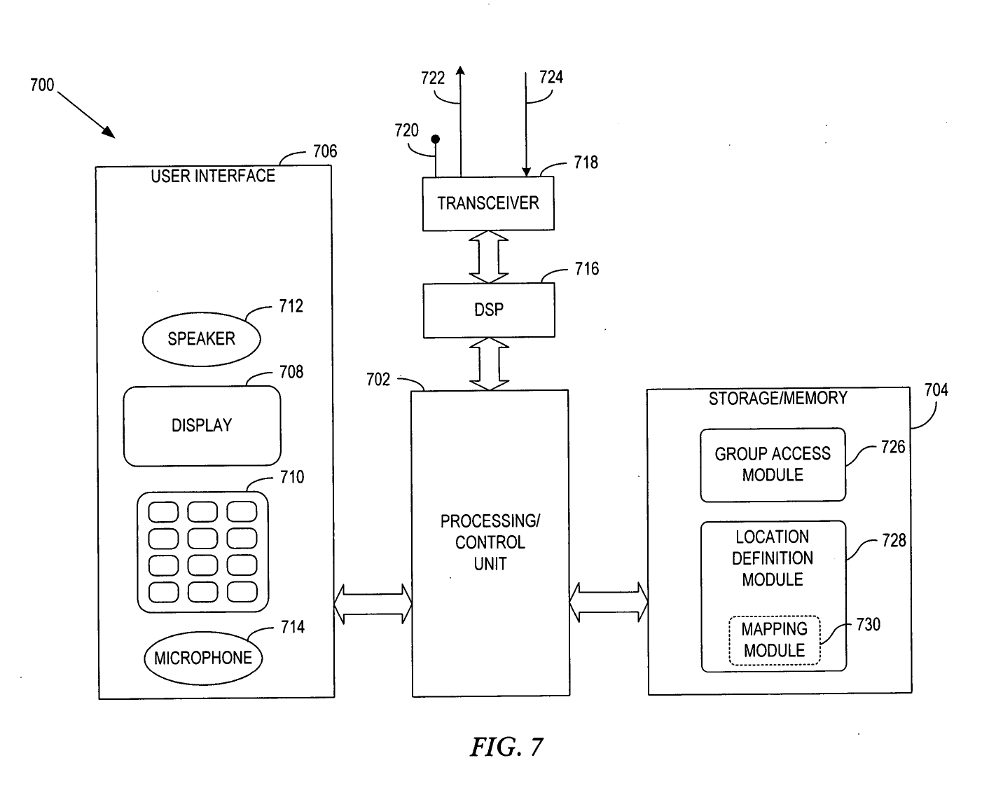

The invention is a modular invention, whereby processing functions within either a mobile terminal or a hardware platform may be utilized to implement the present invention. The mobile terminals may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various group acceptance functions described herein. An example of a representative mobile terminal computing system capable of carrying out operations in accordance with the invention is illustrated in FIG. 7. Those skilled in the art will appreciate that the exemplary mobile computing environment 700 is merely representative of general functions that may be associated with such mobile devices, and also that landline computing systems similarly include computing circuitry to perform such operations.

The exemplary mobile computing arrangement 700 suitable for restricted group access functions in accordance with the present invention may be associated with a number of different types of wireless devices. The representative mobile computing arrangement 700 includes a processing/control unit 702, such as a microprocessor, reduced instruction set computer (RISC), or other central processing module. The processing unit 702 need not be a single device, and may include one or more processors. For example, the processing unit may include a master processor and associated slave processors coupled to communicate with the master processor.

The processing unit 702 controls the basic functions of the mobile terminal, and also those functions associated with the present invention as dictated by group access module 726 and location definition module 728 available in the program storage/memory 704. Thus, the processing unit 702 is capable of defining group boundaries based on location through location definition module 728 and mapping module 730, and is further able to gain access to otherwise restricted groups through group access module 726. The program storage/memory 704 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 704 are stored in non-volatile electrically-erasable, programmable ROM (EEPROM), flash ROM, etc., so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The processor 702 is also coupled to user-interface 706 elements associated with the mobile terminal. The user-interface 706 of the mobile terminal may include, for example, a display 708 such as a liquid crystal display, a keypad 710, speaker 712, and microphone 714. These and other user-interface components are coupled to the processor 702 as is known in the art. Other user-interface mechanisms may be employed, such as voice commands, switches, touch pad/screen, graphical user interface using a pointing device, trackball, joystick, or any other user interface mechanism.

The mobile computing arrangement 700 also includes conventional circuitry for performing wireless transmissions. A digital signal processor (DSP) 716 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 718, generally coupled to an antenna 720, transmits the outgoing radio signals 722 and receives the incoming radio signals 724 associated with the wireless device.

The mobile computing arrangement 700 of FIG. 7 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to implement a system and method of group membership management in accordance with the present invention.

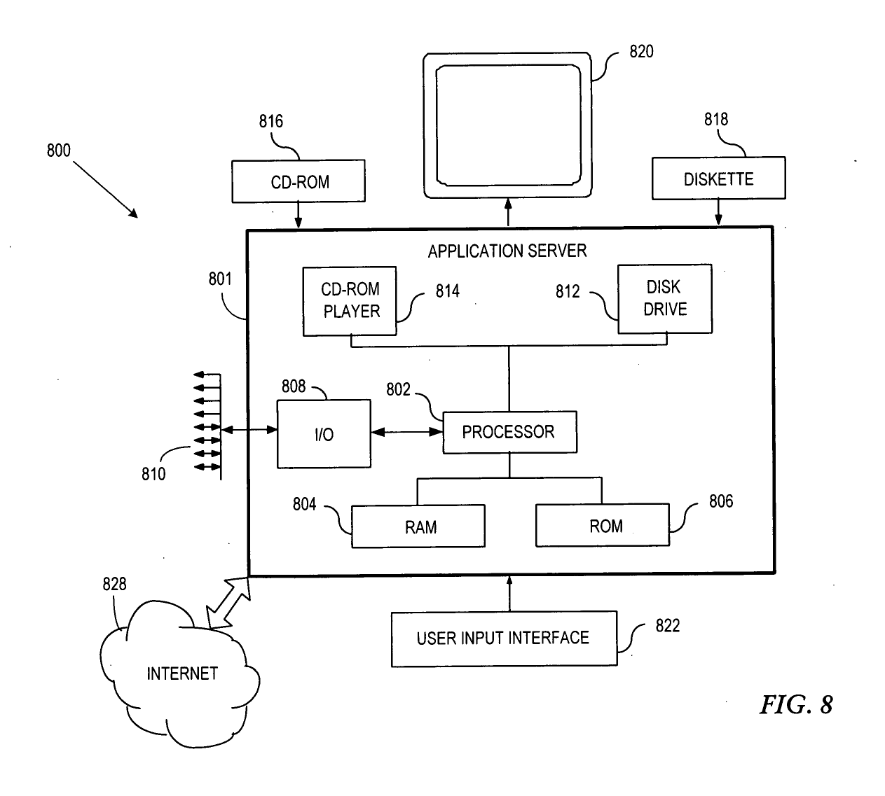

The application servers or other systems for providing server functions in connection with the present invention may be any type of computing device capable of processing and communicating digital information. The server platforms utilize computing systems to control and manage the group access activity. An example of a representative computing system capable of carrying out operations in accordance with the invention is illustrated in FIG. 8. Hardware, firmware, software or a combination thereof may be used to perform the various group access functions and operations described herein. The computing structure 800 of FIG. 8 is an example computing structure that can be used in connection with such an application server platform.

The example computing arrangement 800 suitable for performing the application server activity in accordance with the present invention includes application server 801, which includes a central processor (CPU) 802 coupled to random access memory (RAM) 804 and read-only memory (ROM) 806. The ROM 806 may also be other types of storage media to store programs, such as programmable ROM (PROM), erasable PROM (EPROM), etc. The processor 802 may communicate with other internal and external components through input/output (I/O) circuitry 808 and bussing 810, to provide control signals and the like. For example, data received from I/O connections 808 or Internet connection 828 may be processed in accordance with the present invention. External data storage devices may be coupled to I/O circuitry 808 to facilitate application server functions according to the present invention. Alternatively, such databases may be locally stored in the storage/memory of application server 801, or otherwise accessible via a local network or networks having a more extensive reach such as the Internet 828. The processor 802 carries out a variety of functions as is known in the art, as dictated by software and/or firmware instructions.

Application server 801 may also include one or more data storage devices, including hard and floppy disk drives 812, CD-ROM drives 814, and other hardware capable of reading and/or storing information such as DVD, etc. In one embodiment, software for carrying out the group acceptance operations in accordance with the present invention may be stored and distributed on a CD-ROM 816, diskette 818 or other form of media capable of portably storing information. These storage media may be inserted into, and read by, devices such as the CD-ROM drive 814, the disk drive 812, etc. The software may also be transmitted to application server 801 via data signals, such as being downloaded electronically via a network, such as the Internet. Application server 801 is coupled to a display 820, which may be any type of known display or presentation screen, such as LCD displays, plasma display, cathode ray tubes (CRT), etc. A user input interface 822 is provided, including one or more user interface mechanisms such as a mouse, keyboard, microphone, touch pad, touch screen, voice-recognition system, etc.

Application server 801 may be coupled to other computing devices, such as the landline and/or wireless terminals via a network. The server may be part of a larger network configuration as in a global area network (GAN) such as the Internet 828, which allows ultimate connection to the various landline and/or mobile client/watcher devices.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A method of managing group membership within a network using predefined access restrictions, comprising:
defining access restrictions associated with network group membership;
comparing credentials received from a prospective network group attendee to the predefined access restrictions; and
granting network group membership to the prospective network group attendee when credentials associated with the prospective network group attendee meets the predefined access restrictions.

2. The method according to claim 1, wherein defining the access restrictions includes setting minimum capabilities required for the network group membership.

3. The method according to claim 2, wherein the minimum capabilities include any one or more of gaming capability and video streaming capability.

4. The method according to claim 3, wherein comparing credentials comprises retrieving the capability information from a profile server associated with the prospective network group attendee.

5. The method according to claim 1, wherein comparing credentials comprises retrieving location information from a location server associated with the prospective network group attendee.

6. The method according to claim 5, wherein the predefined access restrictions are met when a location of the prospective network group attendee is within a location area specified for the network group membership.

7. A group management system, comprising:
a plurality of mobile terminals wirelessly coupled to the group management system and adapted to request access to a restricted group;
an application server adapted to receive group access credentials associated with each of the plurality of mobile terminals and to compare the group access credentials to predefined access restrictions; and
a group management module arranged to update group membership in response to group membership messages received from the application server, wherein a mobile terminal is granted access to the restricted group if the group access credentials associated with the mobile terminal satisfy the predefined access restrictions.

8. The group management system according to claim 7, further comprising a profile server associated with the plurality of mobile terminals and adapted to provide capability information to the application server for each of the plurality of mobile terminals.

9. The group management system according to claim 8, wherein the capability information includes any one or more of video streaming and gaming capability.

10. The group management system according to claim 7, further comprising a location server associated with the plurality of mobile terminals and adapted to provide location information to the application server for each of the plurality of mobile terminals.

11. A mobile terminal capable of being wirelessly coupled to a network which includes a restricted access group, the mobile terminal comprising:
a memory capable of storing a group access module;
a processor coupled to the memory and configured by the group access module to submit access requests to the restricted access group; and
a transceiver configured to facilitate content exchange with the restricted access group, wherein credentials associated with the mobile terminal are compared to predefined access restrictions to qualify the mobile terminal for group membership.

12. The mobile terminal according to claim 11, further comprising a location definition module adapted to generate a region of interest to be used as one of the predefined access restrictions.

13. The mobile terminal according to claim 12, wherein the location definition module includes a global positioning system (GPS) module adapted to facilitate a location definition for the mobile terminal.

14. The mobile terminal according to claim 13, wherein the location definition module includes a mapping module adapted to generate map data associated with the current position of the mobile terminal and the region of interest.

15. A computer-readable medium having instructions stored thereon which are executable by a mobile terminal for accessing a restricted group by performing steps comprising:
generating an access request to the restricted group located on a network;
receiving a challenge in response to the access request;
providing a response to the challenge; and
receiving access rights to the restricted group when the response is validated by the network, wherein network access to credentials associated with the mobile terminal are used to determine the access rights of the mobile terminal.

16. The computer-readable medium according to claim 15, further comprising instructions to perform the step of generating the credentials associated with the mobile terminal.

17. The computer-readable medium according to claim 16, wherein the step of generating the credentials associated with the mobile terminal includes generating gaming capability information.

18. The computer-readable medium according to claim 16, wherein the step of generating the credentials associated with the mobile terminal includes generating video streaming capability information.

19. An application server capable of being coupled to a network to facilitate access to a restricted group, the application server comprising:
means for receiving requests from network elements to access the restricted group;
means for validating credentials associated with the network elements; and
means for granting access rights to the restricted groups in response to validation of the credentials of the network elements.

20. A computer-readable medium having instructions stored thereon which are executable by an application server by performing steps comprising:
receiving requests from network elements to access the restricted groups;
validating credentials associated with the network elements; and
granting access rights to the restricted groups in response to validation of the credentials of the network elements.

21. A method of granting access to a restricted group within a network, comprising:
monitoring activity of a terminal within the network;
offering restricted group access to the terminal when the activity of the terminal meets a predefined threshold; and
updating a group management module with membership changes to the restricted group when the terminal accepts membership to the restricted group.

22. The method according to claim 21, wherein monitoring activity of the terminal includes monitoring a gaming activity executing on the terminal.

23. The method according to claim 22, wherein meeting the predefined threshold includes earning at least a minimum score during execution of the gaming activity.
